(19) United States
(12) Patent Application Publication
(10) Pub. No.: US 2002/0091340 A1
(43) Pub. Date: Jul. 11, 2002

(54) Vibration device for use with a resting unit

(76) Inventor: Daniel J. Robbins, Santa Monica, CA (US)

Correspondence Address: OPPENHEIMER WOLEF & DONNELLY LLP, 38th Floor, 2029 Century Park East, Los Angeles, CA, 90067-3024, US

(21) Appl. No.: 09/991,303

(22) Filed: Nov. 13, 2001

Related U.S. Application Data
(60) Provisional application No. 60/248,129, filed on Nov. 13, 2000.

(51) Int. Cl. A61H 1/00

(52) U.S. Cl. 601/46

(57) ABSTRACT

A vibration system includes metal members located on opposite sides of side walls of a box spring. One arm of the metal members is for extending between a mattress and a box spring; and the other arm extends against the side wall of the box spring. The metal member portion extending along the side wall of the box spring includes the structure for locating a vibration generating motor so that the motor is maintained in adjacency relative to the box springs to effectively impart or transfer vibrations from the motor to the box spring. Straps extend between the metal members to anchor the two separated members together.

### BACKGROUND OF THE INVENTION

The present invention relates generally to a system for installing a vibrating device in a user-friendly manner with a box spring, futon, mattress, other similar bed systems, chair, couch or other resting unit.

The known methods of installing a vibrating device inside a box spring have become less effective due to changes in the design of the support springs in the box spring. Prior to the changes in the design of box springs, the support springs were coil-shaped or grid wires. This coil design allowed a user of a vibrating device, with four slotted wheels, to simply screw the device housing into the coil design or grid wire via the spacing in the wheels or via an insertion clip system utilizing multiple system ties.

Typical box springs are made with a series of parallel lattice wires in conjunction with spring coils to create a lattice within the box spring. These parallel wires prevent the insertion of the vibration device in the spring coils due to different spacing widths in the various grid systems. Furthermore, other bed systems, such as a futon bed, have supporting frames with parallel boards. These parallel boards prevent the installation of the vibrating device for the reasons set forth above. Use of a vibrating device affixed solely to the lattice can also be cumbersome.

Therefore, what is needed is an assembly to enable the user to attach the vibrating device to any type of box spring, mattress, bed system, resting system or seating units in a user-friendly manner.

### SUMMARY OF THE INVENTION

The present invention, accordingly, provides an assembly that enables the user to secure a vibration assembly onto any box spring, mattress or resting device in a user-friendly manner.

The invention is directed to providing a mechanism and system for easily installing and removing a vibration device relative to the box spring, mattress or other similar resting or supporting device, and ideally be portable.

According to the invention, there is provided a vibration device for anchoring relative to a resting unit. In one form of the invention, the resting unit usually includes a top, a bottom and side walls. There is a system for anchoring the vibration device adjacent to a side wall of the resting unit. The resting surface or unit is a box spring, mattress or similar bed system. It could include a seat for a chair or a back rest for a chair, a recliner, a hide-away bed, couch, crib or the like.

The vibration device is a motor with an eccentric element, such that rotation of the motor causes the eccentric element to move and cause vibrations to be imparted or transmitted from the vibrating device to the resting unit. In the one preferred form of the invention, the vibration device is strapped to the side wall of the resting unit in a removable manner. Alternatively, it can be installed via multiple slotted holes in the motor casing using nylon ties to connect the vibrating device to the resting unit, for instance, to the underside of the box spring.

Preferably, the strapping includes one or more flexible adjustable length straps which cooperate with one or more rigid, preferably metal, members, supports, grids, frames or housings. There are preferably two rigid metal members which are ideally intended for location in spaced relationship from each other and in mating engagement with one or more side walls. The rigid members preferably are L-shaped at about 90 degrees so that they engage on top of or underneath a resting unit and along a side wall. The adjustable length straps extend between the two spaced rigid elements so that collectively with the elements they embrace or surround the box spring, or mattress or base or the like.

By engaging on top of or underneath the resting unit, the rigid member is secured by a “sandwiching” effect. The sandwiching effect can be between a mattress and a box spring, or between a box spring and the floor, a mattress and the floor, or between the futon and the floor, or between a seat and the floor, or a seat and a base etc.

The resting unit essentially can include a soft padded area, such as a mattress, cushion or the like, and a support for the mattress, cushion or the like. By having the metal member secured along the side wall and also along a top or bottom surface or wall or be sandwiched between a base of the resting device and the floor, this creates effective security and stability to the anchoring means when the vibrating unit is in operative location against the resting unit to which the vibration effect is to be transferred.

Preferably, by having at least a pair of these rigid metal members spaced on opposite sides of side walls and locating one or more straps between the metal members a removable securing system is set up for anchoring a vibrating motor in adjacency with the box spring, bed system, mattress or the like. The metal members are preferably foldable to collapse into substantially the same plane or lie relatively flat. this facilitates storage of the unit when not in use.

One or more of the metal members includes a formation or harness to accommodate the electric motor casing in adjacency with the mattress or resting unit. A support or notch is also provided for the electrical wire of the motor to extend from the motor outwardly to an electrical source. An electrical wire also extends from the motor to a timer for operating the motor at selected time intervals.

In a preferred form of the invention, the system includes two L-shaped collapsible metal members for location on opposite sides of side walls of a box spring. One arm of each of the metal members is for extending between a mattress and a box spring; the other arm is for extending against the side wall of the box spring. The metal member portion extending along the side wall of the box spring includes the structure for locating the motor so that the motor is maintained in adjacency relative to the box springs to effectively impart or transfer vibrations from the motor to the box spring. A first strap set extends between the rods or wire of the metal members which extend between the mattress and the box spring to anchor the two separated members together. A second strap set extends from the ends of the two spaced metal members extending down the side walls to anchor the metal members on the opposite side of the box spring and under the box spring. Each strap set can have an appropriate adjustable buckle as needed.

A principal advantage of this embodiment is that it allows the user of a vibrating device to secure it in an easy manner to any type of box spring or similar bed system.

### BRIEF DESCRIPTION OF THE DRAWINGS

FIG. 1 is a cross-sectional view of one embodiment of the invention with a mattress and a box spring and the system mounted and strapped around a box spring.

FIG. 2 is a cross-sectional view of a different embodiment of the invention with the apparatus and system strapped around a mattress and the metal components being between the mattress and box spring and adjacent to the box spring.

FIG. 3 is a perspective view of the system with two alternative installations on the back rest seat of a chair, couch and/or on a seat portion.

FIG. 4 is a cross-sectional view of the system with a futon with two alternative different installations of the motor on the side wall. In one case the motor is at the head of the futon and in the other case the motor is on the side of the futon

FIG. 5 is a view of one of the metal brackets with straps.

FIG. 6 is a view of a second metal bracket with straps.

FIG. 7 is a perspective view of a mattress showing the metal bracket against the mattress.

FIG. 8a is a different perspective view of FIG. 7 showing the mattress and box spring with the vibrator in the bracket against the mattress.

FIG. 8b is a cross-sectional side view of FIGS. 7 and 8a.

FIG. 9 is a perspective top view of the motor casing.

FIG. 10 is a view of the underneath of the motor casing.

FIG. 11 is a perspective representative alternate illustration of the motor with slotted wheels and clips and straps adjacent to the side wall of a resting unit with the bracket depending down the side wall and also extending horizontally over the top of the side wall, and with straps connected to the bracket. There is also a representation of the timer.

FIG. 12 is a representation of one form of the underside of the motor casing of FIG. 11 showing different brackets and also the electrical connections and timer.

FIG. 13 is a perspective view of the underside of the motor casing and a timer.

FIG. 14 is an internal view of the motor showing the eccentric mounting.

FIG. 15 is a perspective view of a strap with a clip and buckle.

FIG. 16 is a perspective view of ties for use with the motor base for a grid wire box spring system or lattice support.

### DETAILED DESCRIPTION OF THE PREFERRED EMBODIMENT

FIG. 1 shows a mattress 20 mounted on top of a box spring 21. There is a first metal bracket 22, which is mounted to extend downwardly along the side wall of a box spring and partly above the box spring 32 sandwiched between the mattress 20 and the box spring 21. A second metal bracket 23 is mounted on the opposite side of the box spring so that it extends partly downwardly down the box spring partly vertically and sandwiched between the mattress 20 and the box spring 21 horizontally. Extending between the end 24 of bracket 22 and end 25 of bracket 23 is a first strap 26 with a buckle 27 between them. The buckle 27 acts as a system to tighten the strap 26. Underneath the box spring 21 is a second strap 28 with a buckle 29 which acts also to tighten the strap 28, so that the two straps 26 and 28 with the metal brackets 22 and 23 embrace the box spring 21.

Each of the brackets 22 and 23 are hinged so that the arms 30 and 31 respectively of bracket 22. Arms 32 and 33 of bracket 23 can articulate to be folded to be in a substantially flat relationship or to be extended into the substantially L-shape formation as shown in FIG. 1.

There is a vibrator motor 34 mounted with the bracket 22 so as to extend in adjacency along the side wall of the box spring 21. The motor 34 is connected with an electrical cord 35 to an AC supply 36. There is also an electrical cord 37 which connects with the timer 38.

In this manner, the base of the vibrator motor 34 can be located adjacent to wall 39 of the box spring. When the vibrator motor 34 operates, the motor imparts vibrations to the wall 39 and in turn to the box spring 21, which is in turn imparted to the mattress 20.

An advantage of this system of configuring the vibrator motor to be located adjacent to the end or side wall of the box spring 21 is its user-friendly configuration for assembly and disassembly with the box spring 21. To disassemble the vibrator motor 34 from the configuration, the motor 34 needs to be removed from the bracket 22. The straps 26 and 28 are unbuckled respectively through the buckles 27 and 29 and the system can be disassembled.

In some forms of the invention, it is necessary only to have a single strap 28 with buckle 29 to secure the vibrator motor in an operative relationship with the side of the box spring 21. By making the arms 30 and 32 sufficiently long that they are secured in a sandwiched relationship between the mattress 20 and the box spring 21, there can be sufficient security and stability of the brackets in position. The tightened strap 28 provides security so that the vibrator 34 is in effective operable relationship with the side of the box spring 21. The straps 26 and 28 optionally can be used to tighten the relationship to ensure effective operation.

It may well be possible to have a single metal bracket mounting the vibration motor on the side of the box spring 21. This is effected by securing the bracket 22 effectively so that the motor 34 can be in close engagement with the box mattress. This can be achieved by an appropriate extension or formation of the one or more arms of the bracket 22. The formation could be of sufficient length or of a nature to sufficiently secure itself in operative relationship with the side of the box spring.

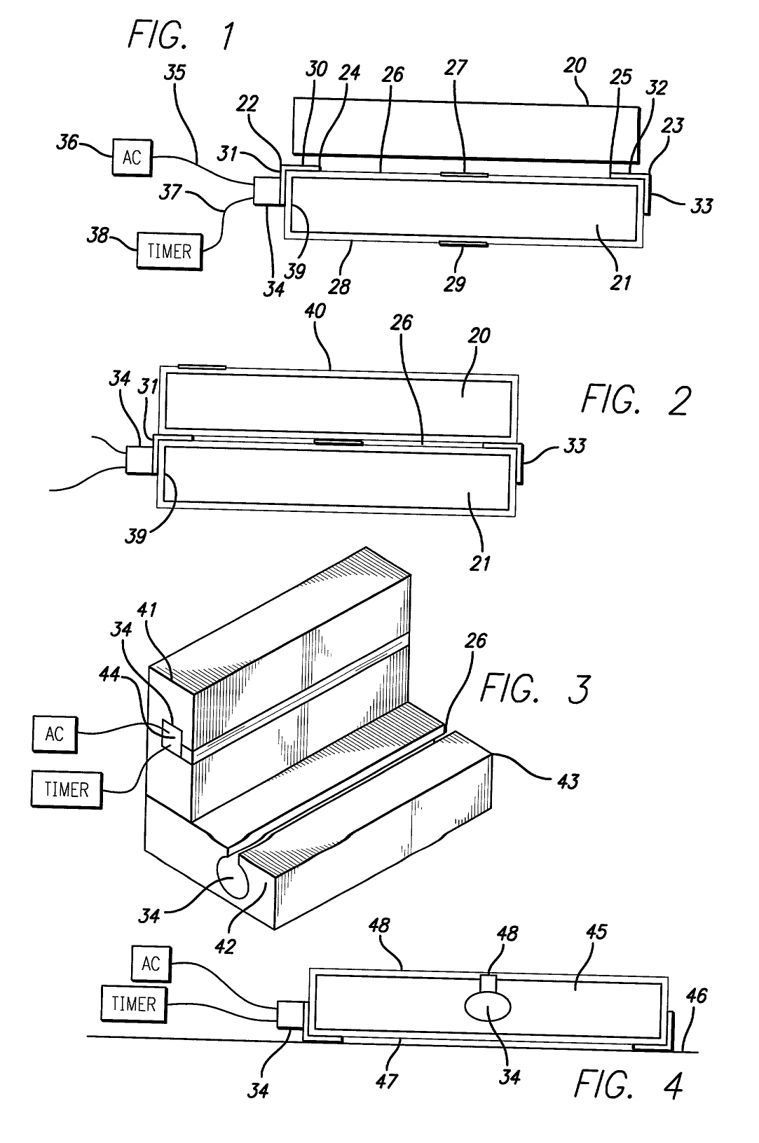

In the relationship shown in FIG. 2 there is shown a box spring 21 and a mattress 20. Here, there is a strap 26 which is sandwiched between the mattress 20 and box spring 21. As illustrated, the strap 40 extends over the top of the mattress 20. The legs 31 and 33 of the brackets 22 and 23 extend downwardly over the box spring. This configuration effectively locates the vibrator motor 34 against the wall 39 of the box spring 21.

In the illustration of FIG. 3 there is a seat with the vibrator motor 34 located in the backrest 41 of the seat. The seat portion 42 extends forwardly from the backrest. A strap 43 goes in front of the backrest 41 and the strap 44 goes around the back of the backrest 41 or the order can be changed so the motor and strap wrap around and over and under the seat portion of the chair.

In FIG. 4 there is illustrated a configuration of a futon 45 located on the base of floor 46. There is a vibrator motor 34 located on the side of the futon and straps 47 and 48 assist in securing the vibrator motor 34 in position. The unit can be installed on the side wall at either the to[ of the bottom or the side wall of the futon

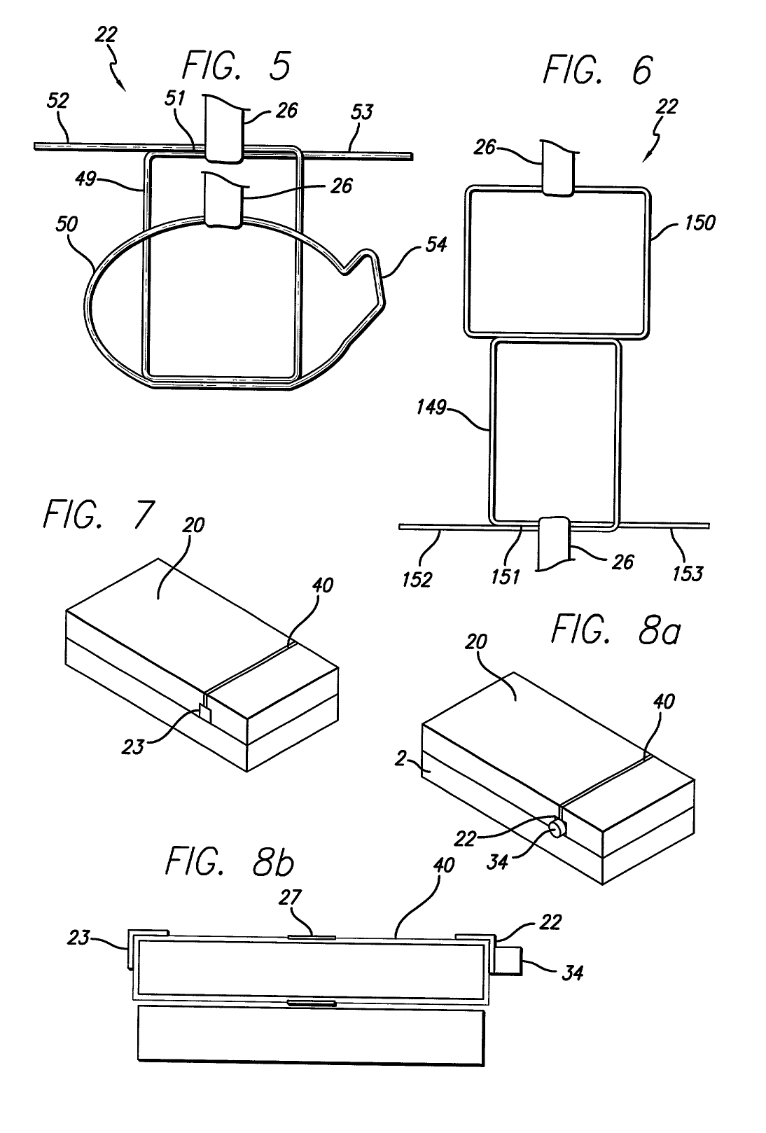

In FIGS. 5 and 6, there are shown the two brackets 22 and 23, respectively. It can be seen to have a rectangular configuration 49 and an elliptical configuration 50, which are directed substantially in a hinged relationship and at right angles to each other. From the end 51 of the portion 49, there are extending rods 52 and 53. This increases the surface area or linear area covered by the portion of the bracket 49 when it extends in the sandwiched relationship either between the mattress and box spring or between the futon and the floor, or the like. The portion 50 also includes a loop or notched area 54 for assisting and accommodating the vibrator motor electrical cords from that motor to a power source and a timer.

The bracket 22 includes the portion 50 with the loop section 54 through which the electrical wires of the motor and timer wires pass. The perimeter 71 of the portion 50 is elliptically shaped in a similar fashion as the outer casing 55 of the motor 34. In this manner, the head portion 55 of the top of the motor passes through the elliptical casing 34 and the ring-like element 71 engages the motor at the juncture between the upright wall 72 and the base section 73 at the interface 74. This permits for a snug accommodation of the motor casing with the elliptical ring element 50 so that when the bracket 22 is mounted in its requisite position relative to the box spring, the base section 56 of the motor can be pulled into tight adjacency with the side wall 39.

In FIG. 6 there is shown the bracket 23 with the rectangular elements 149 and 150, and the free end 151 having extension rods 152 and 153. Element 150 does not have a loop section and does not accommodate the vibrator motor. The bracket 23 has elements 149 and 150 which are substantially rectangular in fashion and are hinged as described. There are extension bars 152 and 153 which extend from bracket 22 and extension bars 152 and 153 which extend from the bracket 23.

In FIG. 7 there is a perspective view showing the bracket 23 in adjacency with the box spring and the strap 40 over the mattress 20.

In FIG. 8 there is a perspective view showing the bracket 22 in a relationship adjacent to the mattress and the strap 40 over the mattress. There is also shown the vibrator motor 34 in a location substantially adjacent to the mattress and also the box spring.

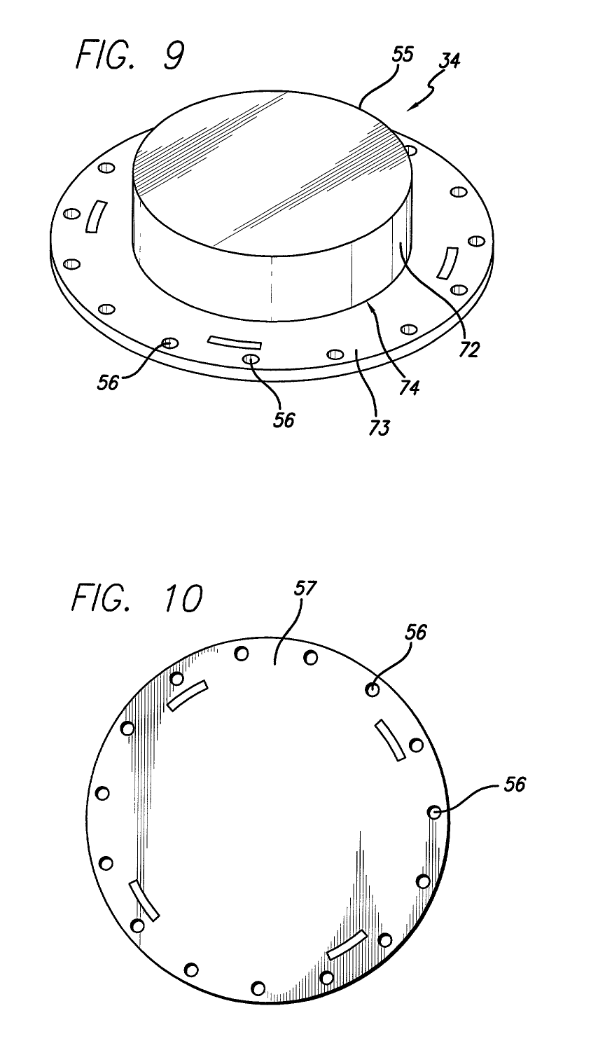

In FIG. 9 there is shown the top portion of the elliptical casing 55 of the vibrator motor 34. There are spaced holes or apertures 56 around the perimeter of the elliptical casing. The under portion 57 is shown in FIG. 10 and has spaced holes or apertures 56 which mate with the apertures 56 in the top. There can be rivets, spot welding, nuts and bolts or the like that extend through these apertures 56 and 56 to secure the parts together. The free end of the rivets or the heads or nuts of bolts act to transmit the vibrations from the motor 34 to the side of the box spring.

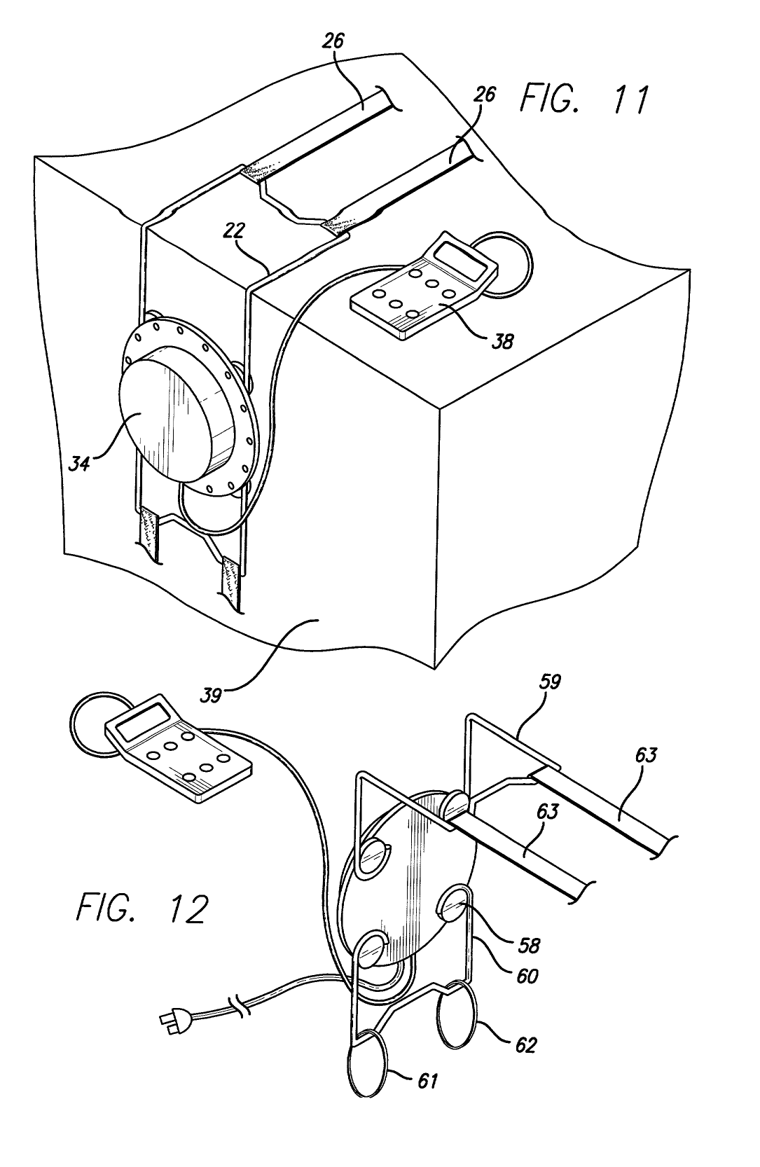

In FIG. 11 there is a perspective view illustrating a representative configuration of the motor 34 mounted with a bracket 22, with the timer 38. There are a pair of straps 26 which are shown extending from the free end of the bracket 22 and for engagement between the mattress 20 on top of a box spring 21. The base of the motor 34 is adjacent to the side wall 39 which is represented in FIG. 11.

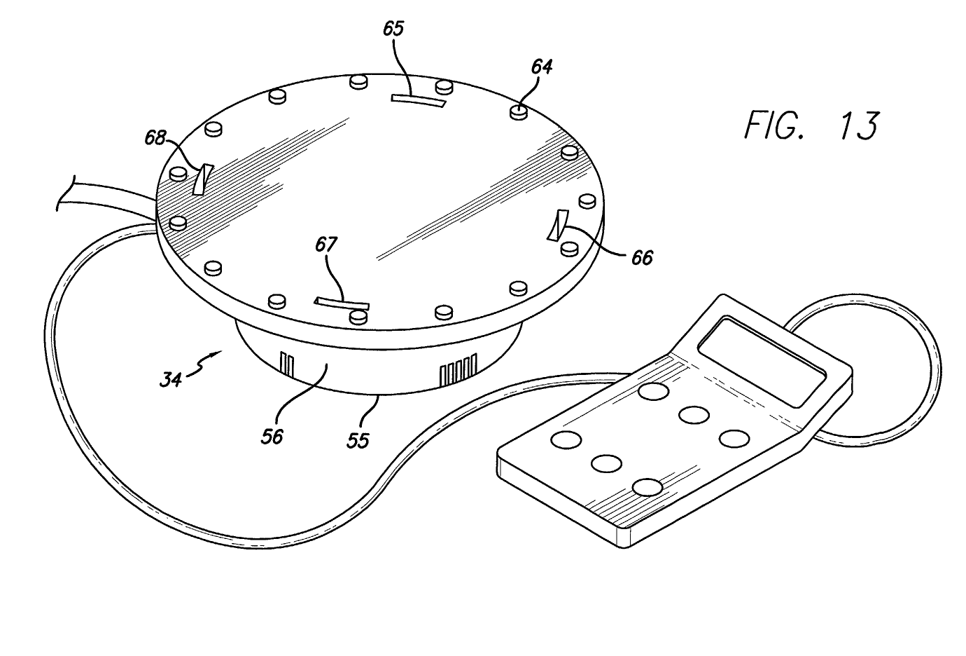

FIG. 12 is a perspective view showing the base of a motor in a different configuration. Here, there are four slotted feet 58 spread rectangularly about the base of the motor. These feet assist in transmitting the vibrations from the motor to the side wall 39 of the box spring. There are also different bracket formations which are illustrated connected to the feet. Here, the bracket 59 is connected to one pair of slotted feet and the bracket 60 is connected to an opposite pair of feet. The bracket 60 includes two nylon ties or straps 61 and 62 which extend from the bracket and can be used to engage straps 63 as necessary. Alternatively, the straps 61 and 62 are in the form of ties which can be anchored to the slats on a box spring. In this configuration of FIG. 12, the brackets are directly mounted with the motor. This is one variation of the system and the other variations, the brackets, essentially are used to relatively loosely accommodate the motor by embracing the motor and urging the motor into an adjacency relationship with the wall 39 of the box spring 21. In that form of the invention, the bracket 22 would go about the outer casing 55 of the motor 34. The straps would be secured to the appropriate free ends of the brackets 22 and 23.

In FIG. 13, there is shown the configuration of the base 56 with the top casing 55 of the motor 34. The heads 64 of the rivets extend from the base 56 and offer engagement with the outer wall 39 of the box spring. There are four slots 65, 66, 67 and 68 around the perimeter of the base 56. These slots accommodate the four nylon tie element 61 and 62 and can be used in different configurations to locate the motor additionally next to slats in an alternative or additional mounting technique for mounting the vibrator motor 34 with the slats under the box spring or around wood slats. In that mounting technique, the vibration motor is mounted underneath the box spring, which may be desirable in certain situations. In that event, the flexible ties or straps 61 or 62 are tightened with the respective slats in an easily connecting manner for securing the vibrator motor 34 in operative relationship.

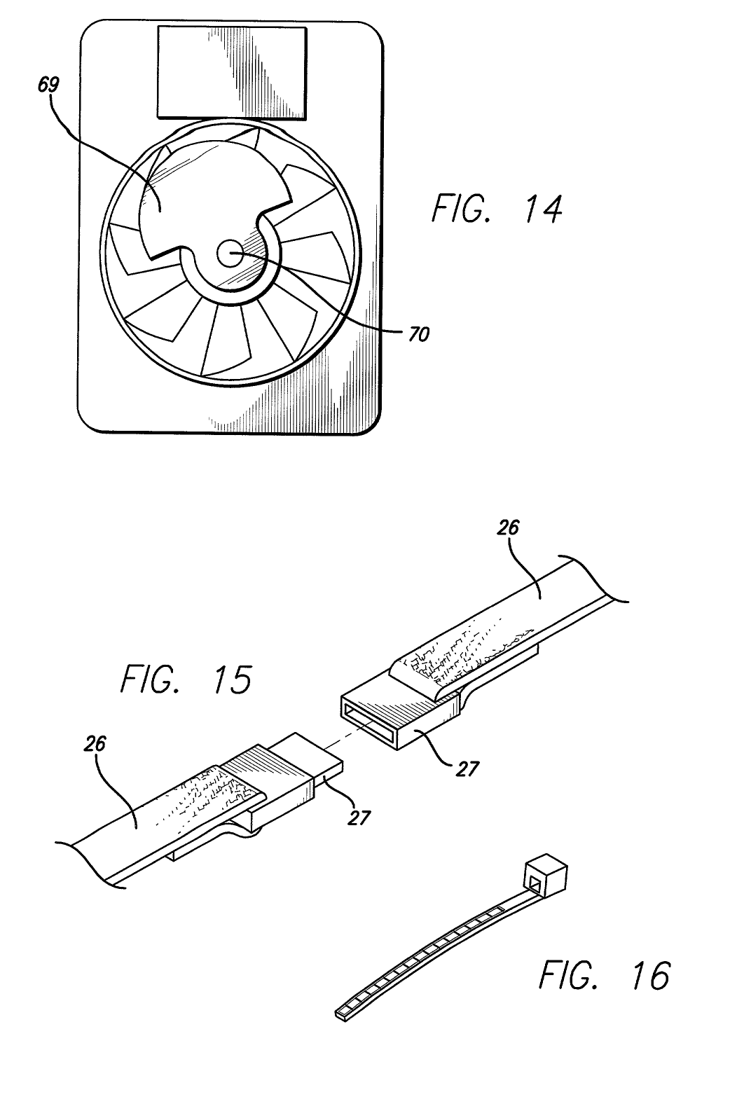

In FIG. 14, there is shown the inside of the motor with an eccentric element 69 mounted for rotation about the axis 70 of the motor. The rotation of the eccentric element 69 causes the motor 34 to vibrate.

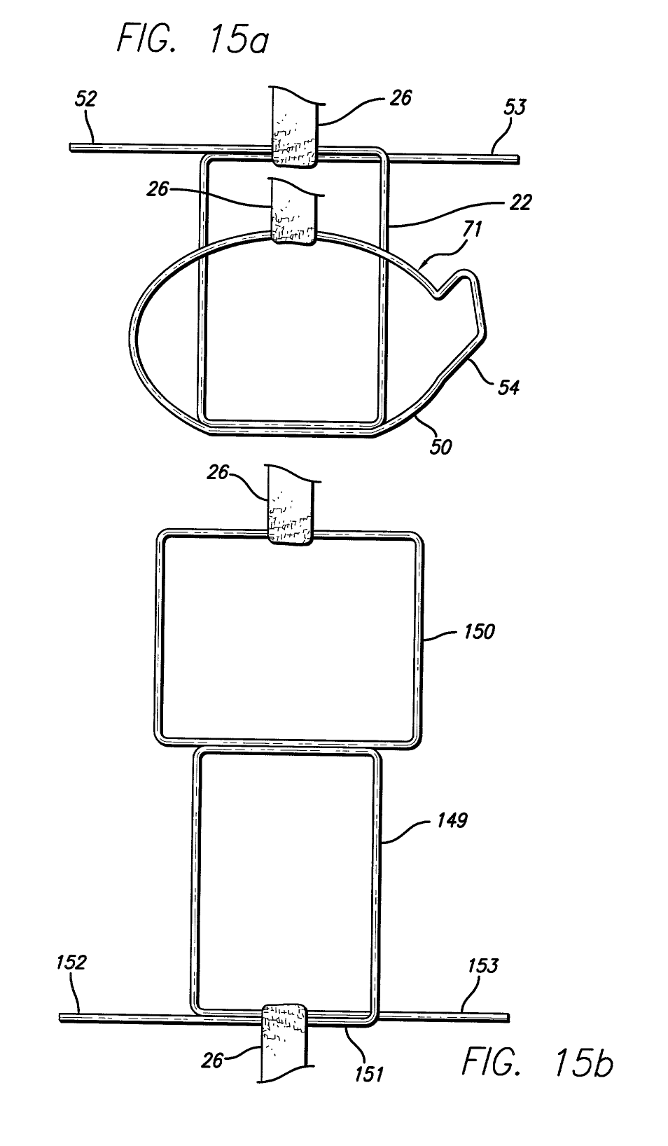

In FIG. 15 there is a representation of a buckle 27 which secures two ends of strap 26.

In FIG. 16 there is a representation of four nylon ties which are for use with the apertures 65, 66, 67 and 68 as necessary.

Operation and Assembly

Leaving the mattress and box spring in place, slide nylon strap set attached to the shaped brackets between box spring and mattress. Brackets 22 and 23 should be placed on each side of box spring with bracket bottoms facing down so that second nylon strap set can attach around the underneath of the box spring. Hang each 90 degree angle draped over end of box spring. Pull strap from buckle until each side is firmly in place at a 90° angle to the bed ends. Slide motor unit 34 into bracket 23 with the base 56 of unit against box spring. Be sure to insert so that power and timer cords are located into notched oval bracket cutout 54.

With unit 34 held securely in place with fastened upper nylon straps 26, attach underneath strap 28 around bottom of box spring, insert into buckle and tighten until entire unit is firmly in place.

Alternative System Installation

The simple-to-use installation method can be used in other types of sleep systems. If no box spring exists such as in futons, foundation beds, hide-a-ways and folding beds, simply wrap the straps around the mattress in the same manner as described above and connect underneath. Secure tightly and you're ready in minutes.

For those who prefer placing the massaging motor directly into the box spring for a permanent installation, there are four nylon ties which are threaded into the small slots on the four sides of the motor base. To utilize this method, simply hang the unit upside down with the base (bottom) of the unit against the grid wire or wooden supports and tie around four opposing areas to securely hold the motor tightly in place. Wrap the ties evenly looped around support or grid wires and it is complete. In this fashion the motor is located in an upside down hanging relationship underneath the grid wires, slats or wooden supports.

Setting the Clock Timer

1) Plug power cord into wall outlet—LED should flash “12:00”.

2) Set timer button on side to “REAL TIME”, then touch “HRS” and “MIN” to set actual time. Note: “PM” indicator light on LED display.

3) To program the massaging motor to start at a specific time, hold down button marked “ALARM SET MAGIC FINGERS”. Touch “HRS” and “MIN” buttons to desired time. Move the side switch to “MAGIC FINGERS”. The indicator alarm light (ALM) on the LED will remain on. When activated by alarm setting, the unit will remain on for 2 hours.

4) To activate unit at any time, press “ON” button. The unit will activate for 59 minutes.

5) Touch “OFF” button stop unit.

6) To operate unit for a desired amount of time (e.g. 25 minutes only), touch and hold down the “ON” and “MIN” buttons to activate 59 minute countdown until desired massage time is obtained, then release both buttons. The unit will remain on for the balance of time shown.

7) Real time is displayed at all times unless “ALARM SET MAGIC FINGERS” button is touched, revealing pre-set activation time.

Technical Specifications

| | |
|---|---|
| Power: | 120 v 60 hz |
| Motor and timer: | 22 watts |
| Motor size: | 8″ L × 5⅜” W × 3″ H |
| Timer size: | 2¼″ L × 3½” W × 1″ H |

Although illustrative embodiments have been shown and described, a wide range of modifications, changes and substitutions is contemplated in the foregoing disclosure and in some instances, some features of the embodiments may be employed without a corresponding use of other features.

Accordingly, the invention be construed broadly and in a manner consistent with the scope of the embodiments disclosed herein. For instance, the side wall of the resting device can constitute any one of the front, back or sides of the resting unit. In some cases there may be a single rigid member, and in other cases there may be no rigid member if the system is structured so that the vibrator motor is effectively secured to the side wall of the box spring or the like by the wrap around straps.

What is claimed is:

1. An assembly for securing a vibration assembly onto a box spring, mattress or resting surface comprising:
a vibration device for anchoring relative to a resting unit, the resting unit including a top, a bottom and side walls, and a system for anchoring the vibration device adjacent to a side wall of the resting surface; and
the vibration device including a motor with an eccentric element, such that rotation of the motor causes the eccentric element to move and cause vibrations to be imparted or transmitted from the vibrating device to the resting surface.

2. An assembly as claimed in claim 1 wherein the resting surface is a box spring, mattress or similar bed system.

3. An assembly as claimed in claim 1 including strapping for securing the vibration device to the side wall of the resting unit in a removable manner.

4. An assembly as claimed in claim 3 wherein strapping includes one or more flexible adjustable length straps which cooperate with one or more rigid metal, members, supports, grids, frames or housings.

5. An assembly as claimed in claim 4 including two relatively rigid metal members for location in spaced relationship from each other and in mating engagement with one or more side walls.

6. An assembly as claimed in claim 5 where the rigid members preferably are L-shaped at about 90 degrees so that they engage on top of or underneath a resting surface and along a side wall.

7. An assembly as claimed in claim 4 wherein the strapping includes adjustable length straps extending between two spaced rigid elements so that collectively with the rigid elements they embrace or surround the box spring, or mattress or base.

8. An assembly as claimed in claim 1 including a metal member secured along the side wall and also along a top or bottom surface or wall or be sandwiched between a base of the resting device and a floor, thereby to create effective security and stability to the anchoring means when the vibrating device is in operative location against the resting unit to which the vibration effect is to be transferred.

9. An assembly as claimed in claim 8 including at least a pair of the metal members spaced on opposite sides of side walls and one or more straps between the opposite metal members thereby forming a removable securing system for anchoring a vibrating device in adjacency with the box spring, bed system, or mattress.

10. An assembly as claimed in claim 6 wherein the metal members are foldable to collapse into substantially the same plane or lie relatively flat.

11. An assembly as claimed in claim 5 wherein one or more of the metal members includes a formation or harness to accommodate an electric motor casing in adjacency with the mattress or resting unit.

12. An assembly as claimed in claim 11 including a support or notch for the electrical wire of the motor to extend from the motor outwardly to an electrical source.

13. An assembly as claimed in claim 1 including two L-shaped collapsible metal members for location on opposite sides of side walls of a box spring, one arm of each of the metal members being for extending between a mattress and a box spring, and the other arm being for extending against the side wall of the box spring.

14. An assembly as claimed in claim 13 wherein the metal member portion extends along the side wall of the box spring and includes a structure for locating the motor so that the motor is maintained in adjacency relative to the box springs to effectively impart or transfer vibrations from the motor to the box spring.

15. An assembly as claimed in claim 1 including a first strap set extending between rods or wire of a first metal member for securing the vibration device, the first strap being for extending between a mattress and a box spring to connection with a second separated metal member, and a second strap set extending from ends of the two spaced metal members and being for extending down the side walls to anchor the metal members on the opposite side of the box spring and under the box spring.

16. An assembly as claimed in claim 15 where each strap set includes an adjustable buckle thereby to permit adjustment of the strap length.

17. An assembly for securing a vibration assembly onto a box spring, mattress or resting surface comprising:
a vibration device for anchoring relative to a resting unit, the resting unit including a top, a bottom and side walls, and a system for anchoring the vibration device adjacent to the resting surface;
the vibration device including a motor with an eccentric element, such that rotation of the motor causes the eccentric element to move and cause vibrations to be imparted or transmitted from the vibrating device to the resting surface;
strapping for securing the vibration device to the resting surface, the strapping cooperating with one or more rigid metal, members.

18. An assembly as claimed in claim 17 where the rigid members preferably are L-shaped at about 90 degrees so that they engage on top of or underneath a resting unit and along a side wall.

19. An assembly as claimed in claim 18 including at least a pair of the metal members spaced on opposite sides of side walls and one or more straps between the opposite metal members thereby forming a removable securing system for anchoring a vibrating device in adjacency with the box spring, bed system, or mattress, the metal members are foldable to collapse into substantially the same plane or lie relatively flat, and wherein one or more of the metal members includes a formation or harness to accommodate an electric motor casing in adjacency with the mattress or resting surface.

20. An assembly for securing a vibration assembly onto a box spring, mattress or resting device comprising:
a vibration device for anchoring relative to a resting unit, the resting unit including a top, a bottom and side walls, and a system for anchoring the vibration device adjacent to a wall of the resting unit;
the vibration device including a motor with an eccentric element, such that rotation of the motor causes the eccentric element to move and cause vibrations to be imparted or transmitted from the vibrating device to the resting unit; and.
the vibration device includes multiple slotted holes in a motor casing, and ties for connecting the vibrating device to the resting unit.
